(19) United States
(12) Patent Application Publication
(10) Pub. No.: US 2014/0228135 A1
(43) Pub. Date: Aug. 14, 2014

(54) GREASE COMPOSITION FOR CONSTANT VELOCITY JOINT AND CONSTANT VELOCITY JOINT

(71) Applicants: KYODO YUSHI CO., LTD., Fujisawa-shi (JP); NTN Corporation, Osaka-shi (JP)

(72) Inventors: SHINYA KONDO, Fujisawa-shi (JP); Akira Taniguchi, Fujisawa-shi (JP); Ko Tanimura, Fujisawa-shi (JP); Shinichi Takabe, Iwata-shi (JP); Takaaki Shibata, Iwata-shi (JP); Shinya Chuujou, Iwata-shi (JP)

(73) Assignees: KYODO YUSHI CO., LTD., Fujisawa-shi (JP); NTN Corporation, Osaka-shi (JP)

(21) Appl. No.: 14/258,495

(22) Filed: Apr. 22, 2014

Related U.S. Application Data
(63) Continuation of application No. 12/521,347, filed on Jun. 26, 2009.
Application No. 12/521,347 is a continuation of application No. PCT/JP2007/075247, filed on Dec. 28, 2007.

(30) Foreign Application Priority Data
Dec. 28, 2006 (JP) 2006-354712

(51) Int. Cl. C10M 169/00; F16D 3/16; C10M 115/08; C10M 141/12; C10M 105/04; C10M 105/36

(52) U.S. Cl. CPC C10M 169/00; C10M 105/04; C10M 105/36; C10M 115/08; C10M 141/12; F16D 3/16; C10M 2215/006; C10M 2203/003; C10M 2207/2855
USPC 464/106; 508/168

(57) ABSTRACT

A grease composition which provides, in the working range of 150° C. to −40° C., an enhanced temperature control performance, a reduced low-temperature rotational torque and an improved boot resistance; and a constant velocity joint wherein the grease composition is filled; are provided. A grease composition for a constant velocity joint comprising the following components (A) to (E):

(A) a base oil containing 10 to 95% by mass of an ester synthetic oil produced from an aliphatic alcohol and an aromatic carboxylic acid and 90 to 5% by mass of a synthetic hydrocarbon oil;

(B) a thickener;

(C) molybdenum disulfide;

(D) molybdenum dialkyldithiocarbamate e; and

(E) zinc dithiophosphate.

This application is a continuation of the U.S. patent application Ser. No. 12/521,347, filed Jun. 26, 2009, which is a U.S. national phase of International Application No. PCT/JP2007/075247, filed Dec. 28, 2007, which designated the U.S. and claims priority to Japan Application No. 2006-354712, filed Dec. 28, 2006; the entire contents of each of the above are hereby incorporated by reference.

### TECHNICAL FIELD

The present invention relates to a grease composition which reduces the low-temperature rotational torque and which provides an improved boot resistance, heat resistance and temperature control performance, and to a constant velocity joint wherein the grease composition is filled. More particularly, the present invention relates to a grease composition which provides improved high-speed durability of a constant velocity joint, a reduced low-temperature starting rotational torque, an enhanced boot resistance due to improvement of the swelling property of rubber and an improved temperature control performance, and to a constant velocity joint wherein the grease composition is filled.

### BACKGROUND ART

Today, in the automotive industry, production of FF vehicles are increasing from the view points of weight saving and sufficiency of the interior space. Further, 4WD vehicles are also increasing from the view point of their functionality. In these FF vehicles and 4WD vehicles, transmittance of power and steering is attained with front wheels, so that, in order to attain smooth transmittance of the power even, for example, in the state where the steering wheel is fully turned, a drive shaft composed of a constant velocity joint capable of transmitting rotational movement at a constant rate irrespective of various changes in the crossing angle between the two crossing axes is used.

On the other hand, FR vehicles and 4WD vehicles have a structure wherein the power from the engine is transmitted to the drive shaft for rear wheels through a propeller shaft which is known to act as a source and channel for transmission of noise and vibration. In place of a propeller shaft composed of conventionally used Cardan joint and a sliding spline, a propeller shaft composed of a constant velocity joint capable of sliding axially while rotating at a constant rate at an operating angle is now becoming widely used.

Since, in recent years, performance improvement of automobiles is being increasingly promoted and high-powered automobiles are increasing, the load on the constant velocity joint is also increasing, so that there is a tendency that its lubrication condition becomes severer. On the other hand, there is also a tendency that improvement of vehicle ride quality is more and more highly demanded.

Especially, although the load torque on a propeller shaft is lower than that on a drive shaft, the operating condition of a propeller shaft is different from that of a propeller shaft: for example, a propeller shaft is used with faster rotation. Therefore, the grease used for a constant velocity joint is required to exhibit improved high-speed performance such as high-speed durability and low vibration at high speed.

The amount of heat (amount of rise in temperature) generated upon rotation of a constant velocity joint may be employed as an index for its high-speed performance, which amount of rise in temperature enables expectation of the critical operating condition. Since the amount of the heat generated tends to depend on the friction coefficient of the grease, development of a grease which exerts an excellent temperature control performance at high temperature is desired.

On the other hand, smooth operation of a constant velocity joint in an extremely cold region is also considered to be important. In an extremely cold region, an automobile may need to be started in a cold condition. In such a condition, it is important to reduce the low-temperature rotational torque of the grease in order to start the automobile smoothly.

However, a grease composition for a constant velocity joint, which grease composition has an excellent temperature control performance and durability and enables sufficient reduction of the low-temperature rotational torque, has not been proposed yet.

Conventionally, as the lubricant, a grease composition for a constant velocity joint, which grease composition containing a base oil, a diurea thickener and, as an additive, a molybdenum compound, has been proposed (see, for example, Patent Documents 1, 2, 4, 5, 7 and 8).

A grease composition containing a grease composed of a specific trimellitate and a thickener, in which grease a compound having a sulfur atom is included, has also been proposed (see, for example, Patent Document 3).

The rotational resistance of a constant velocity joint of an automobile is largely affected not only by the internal resistance of the constant velocity joint but also by the hardness of the boot. Especially, at low temperature, increase in the starting torque and the rotational resistance lead to decrease in operability in terms of steering and the like. In a constant velocity joint having, for the purpose of keeping the rotational resistance of the constant velocity joint low, a boot for preventing grease leakage from the inside of the constant velocity joint and invasion of foreign matters, silicone rubber and chloroprene rubber boot materials satisfying the conditions of not more than 55 at normal temperature (25° C.) and not more than 85 at low temperature (−40° C.) according to JIS K 6253 durometer hardness A type have been proposed (see, for example, Patent Document 6).

However, performances of these grease compositions for constant velocity joints are insufficient in terms of the temperature control performance and the performance for decreasing the low-temperature rotational torque, so that an improvement to achieve more stable performance is desired. Further, in cases where a silicone rubber, chloroprene rubber or the like is used as a boot material, performances such as oil resistance, flex resistance, water resistance, weather resistance, heat resistance and cold resistance are demanded, but there has not yet been a proposal of a grease composition useful for achieving a longer operating life of these various rubber boot materials.

Patent Document 1 JP 10-273691 A

Patent Document 2 JP 10-273692 A

Patent Document 3 JP 11-131082 A

Patent Document 4 JP 2001-11481 A

Patent Document 5 JP 2003-165988 A

Patent Document 6 JP 2005-214395 A

Patent Document 7 JP 2005-226038 A

Patent Document 8 JP 2006-16481 A

### DISCLOSURE OF THE INVENTION

### Problems to be Solved by the Invention

An object of the present invention is to provide a grease composition which enhances the temperature control performance of a constant velocity joint, reduces the low-temperature rotational torque and improves the boot resistance in the working range of 150° C. to −40° C.

Another object of the present invention is to provide a constant velocity joint wherein the above grease composition is filled.

### Means for Solving the Problems

The present inventors intensively studied to achieve the above objects to discover that a grease composition containing specific components may control generation of heat from a constant velocity joint, reduce the low-temperature rotational torque and improve the boot resistance in the working range of 150° C. to −40° C. The grease composition of the present invention for a constant velocity joint was completed based on this discovery.

That is, the present invention provides the following grease composition for a constant velocity joint and a constant velocity joint.

1. A grease composition for a constant velocity joint, which grease composition comprises the following components (A) to (E):

(A) a base oil containing 10 to 95% by mass of an ester synthetic oil produced from an aliphatic alcohol and an aromatic carboxylic acid and 90 to 5% by mass of a synthetic hydrocarbon oil;

(B) a thickener;

(C) molybdenum disulfide;

(D) molybdenum dialkyldithiocarbamate; and

(E) zinc dithiophosphate.

2. The grease composition for a constant velocity joint, according to the above item 1, wherein the synthetic hydrocarbon oil of the component (A) is a poly-α-olefin.

3. The grease composition for a constant velocity joint, according to the above item 1 or 2, wherein the ester synthetic oil of the component (A) is produced from a C₆-C₂₂ aliphatic alcohol and a C₈-C₂₂ aromatic carboxylic acid having 2 to 6 carboxyl groups.

4. The grease composition for a constant velocity joint, according to any one of the above items 1 to 3, wherein the thickener of the component (B) is a urea compound.

5. The grease composition for a constant velocity joint, according to any one of the above items 1 to 4, wherein each of the contents of molybdenum disulfide of the component (C), molybdenum dialkyldithiocarbamate of the component (D) and zinc dithiophosphate of the component (E) is 0.1 to 10% by mass based on the total mass of the grease composition.

6. A constant velocity joint wherein the grease composition according to any one of the above items 1 to 5 is filled.

### EFFECTS OF THE INVENTION

The grease composition of the present invention enhances the temperature control performance of a constant velocity joint, reduces the low-temperature rotational torque and improves the boot resistance in the working range of 150° C. to −40° C. Therefore, faster rotation of a propeller shaft becomes possible, and an automobile may be started under a low temperature condition, enabling to avoid a trouble in the constant velocity joint in an extremely cold region.

Furthermore, the grease composition of the present invention reduces deterioration of a boot material, so that a longer life thereof may be achieved.

The grease composition of the present invention may be used more preferably for a cross groove constant velocity joint which is especially suitable for reducing backlash at high speed rotation.

### EMBODIMENTS FOR CARRYING OUT THE INVENTION

The present invention will now be described in more detail.

The grease composition of the present invention for a constant velocity joint is characterized in that it contains the above components (A) to (E) as indispensable components. Each of these components will now be described.

The base oil used in the present invention containing 10 to 95% by mass of an ester synthetic oil and 90 to 5 weight percent of a synthetic hydrocarbon oil may also be a mixture with other synthetic oils and/or mineral oils. Examples of the other synthetic oils include ether synthetic oils such as alkyl diphenyl ether and polypropylene glycol; silicone oils and fluorinated oils.

Preferred examples of the synthetic hydrocarbon oils used for the component (A) include poly-α-olefins and polybutenes.

The ester synthetic oils used for the component (A) are ester synthetic oils which may be produced from a C₆-C₂₂, preferably C₆-C₁₀ aliphatic alcohol and a C₈-C₂₂, preferably C₈-C₁₂ aromatic carboxylic acid having 2 to 6 carboxyl groups. Specific examples of the C₆⁻C₂₂ aliphatic alcohol include aliphatic alcohols such as 1-hexanol, 2-hexanol, 3-hexanol, 1-heptanol, 4-methyl-2-pentanol, 2-heptanol, 3-heptanol, 1-octanol, 2-octanol, 2-ethyl-l-hexanol, 1-nonanol, nonane-2-ol, 3,5,5-trimethyl-1-hexanol, 1-decanol, 1-undecanol, lauryl alcohol, myristyl alcohol, cetyl alcohol, 14-methylhexadecane-1-ol, stearyl alcohol, oleyl alcohol, 16-methyloctadecanol, icosanol, isodecyl alcohol, 18-methylnonadecanol, 18-methylicosanol, docosanol, 20-methylhenicosanol and 2-octyldodecanol.

Preferred among these are 1-hexanol, 2-ethyl-1-butanol, 1-octanol, 1-heptanol, 2-octanol, 2-ethyl-1-hexanol, nonane-2-ol, 2-ethyl-1-octanol, isodecyl alcohol and 2-2-octyldodecanol.

Specific examples of the C₈-C₁₂ aromatic carboxylic acids having 2 to 6 carboxyl groups include phthalic acid, isophthalic acid, terephthalic acid, 5-methylisophthalic acid, 4,5-dimethoxyphthalic acid, hemimellitic acid, trimellitic acid, trimesic acid, mellophanic acid, prehnitic acid, pyromellitic acid and mellitic acid.

Preferred among these are 5-methylisophthalic acid, trimellitic acid and pyromellitic acid.

Specific examples of the ester synthetic oils produced from the above aliphatic alcohol and aromatic carboxylic acid include hexyl phthalate, 2-ethylbutyl phthalate, octyl phthalate, heptyl phthalate, 2-octyl phthalate, 2-ethylhexyl phthalate, nonane-2-ol phthalate, 2-ethyloctyl phthalate, nonane-2-ol isophthalate, 2-ethyloctyl isophthalate, octyl 5-methyl isophthalate, nonane-2-ol 5-methyl isophthalate, hexyl terephthalate, octyl terephthalate, hexyl trimellitate, octyl trimellitate, heptyl trimellitate, 2-ethylbutyl trimellitate, 2-ethylhexyltrimellitate, nonane-2-ol trimellitate, isodecyl alcohol trimellitate, octyl benzenetetracarboxylate, heptyl benzenetetracarboxylate, hexyl benzenetetracarboxylate, 2-ethylbutyl benzenetetracarboxylate, 2-ethyloctyl benzenetetracarboxylate and 2-octyldodecanol pyromellitate. All of these esters are full esters wherein all the carboxylic acids are esterified.

In the base oil of the present invention, the total amount of the ester synthetic oils and the synthetic hydrocarbon oils of the component A is not less than 40% by mass, preferably not less than 60% by mass, more preferably not less than 80% by mass and most preferably 100% by mass, based on the total base oil.

Preferred examples of the thickener of the component (B) used in the present invention include diurea thickeners represented by the following General Formula (1).

R¹NH—CO—NH—C₆H₄-p-CH₂-C₆H₄-p-NH—CO—NHR² (1)

wherein R¹ and R² may be the same or different and may be C₈-C₂₀, preferably C₈-C₁₈ alkyl; C₆-C₁₂, preferably C₆-C₇ aryl; or C₆-C₁₂, preferably C₆-C₇ cycloalkyl.

The diurea thickeners may be obtained for example by reacting a prescribed diisocyanate and a prescribed monoamine. Preferred examples of the diisocyanates include diphenylmethane-4,4′-diisocyanate. Preferred examples of the monoamines include aliphatic amines, aromatic amines, alicyclic amines and mixtures thereof. Specific examples of the aliphatic amines include octylamine, dodecylamine, hexadecylamine, octadecylamine and oleylamine Specific examples of the aromatic amines include aniline and p-toluidine. Specific examples of the alicyclic amines include cyclohexylamine.

The component B is preferably an aliphatic urea thickener obtained using, among the above-described monoamines, octylamine, dodecylamine, hexadecylamine, octadecylamine or oleylamine or a mixture thereof.

The content of the thickener of the component (B) may be an amount with which a necessary consistency can be obtained, and is normally preferably 1 to 30% by mass, more preferably 5 to 20% by mass based on the total mass of the grease composition.

In general, the component (C), molybdenum disulfide, used in the present invention is widely used as a solid lubricant in a constant velocity joint. In the lubrication mechanism thereof, it is known to have a layer lattice structure which is easily delaminated due to slide motion to decrease frictional resistance. It is also effective for prevention of seizing of a constant velocity joint.

The content of the component (C) is preferably 0.1 to 10% by mass, more preferably 0.5 to 5% by mass based on the total mass of the grease composition.

Specific examples of the component (D), molybdenum dialkyldithiocarbamate, used in the present invention include those represented by the following General Formula (2).

[R³R⁴N—CS—S]₂-Mo₂OₘSₙ (2)

wherein R³ and R⁴ represent each independently C₁-C₂₄, preferably C₂-C₁₈ alkyl; m represents 0 to 3; n represents 1 to 4; and m+n=4.

The content of the component (D), molybdenum dialkyldithiocarbamate, is preferably 0.1 to 10% by mass, more preferably 0.5 to 5% by mass based on the total mass of the grease composition.

Examples of the component (E), zinc dithiophosphate, used in the present invention include those represented by the following General Formula (3).

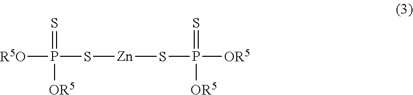

wherein R⁵ represents C₁-C₂₄ alkyl or C₆-C₃₀ aryl, preferably C₁-0₅ alkyl.

The content of the component (E), zinc dithiophosphate, is preferably 0.1 to 10% by mass, more preferably 0.5 to 5% by mass based on the total mass of the grease composition.

In addition to the above components, additives normally used for a grease composition, such as other extreme pressure additives, antioxidants, rust inhibitors and corrosion inhibitor, may be included in the grease composition of the present invention.

Examples of a constant velocity joint wherein the torque transmission member of the constant velocity joint of the present invention is spherical include fixed type constant velocity joints such as those of the Rzeppa type, Birfield type and the like and sliding type constant velocity joints such as those of the double offset type, cross groove type and the like. These have a structure wherein a ball is used as the torque transmission member, which ball is arranged on tracks formed on an outer race and an inner race of the constant velocity joint and incorporated via a cage.

Examples of a constant velocity joint wherein the constant velocity joint of the present invention is a fixed type constant velocity joint include the above mentioned fixed type constant velocity joints such as those of the Rzeppa type, Birfield type and the like.

Examples of a constant velocity joint wherein the constant velocity joint of the present invention is a plunging type constant velocity joint include the above mentioned plunging type constant velocity joints such as those of the double offset type, cross groove type and the like, which may be at an operating angle while being capable of sliding axially.

### EXAMPLES

The present invention will now be described in more detail by way of Examples.

### [Examples 1-4, Comparative Examples 1-8]

### Preparation of Grease Composition

In a container, 1050 g of the base oil and 294.3 g of diphenylmethane-4,4′-diisocyanate were added and heated to 70 to 80° C. In a separate container, 460 g of the base oil and 605.7 g of octadecylamine were added and heated to 70 to 80° C., which resulting mixture was then added to the above container, followed by allowing the reaction for 30 minutes with thorough stirring. The resulting reaction product was allowed to cool to obtain a base urea grease. To this base urea grease, additives were added according to the formulations shown in Tables 2 to 4, and the base oil was appropriately added thereto, followed by adjusting the obtained mixture to the No. 1 grade of the consistency by a 3-roll mill.

### Evaluation

### (1) Viscosity of Base Oil

Measurement in accordance with JIS K 2283.

Viscosity of the base oil at 100° C. was measured.

### (2) Low-temperature Torque (−40° C.)

Measurement in accordance with JIS K 2220 18.

The starting torque at −40° C. was measured.

The evaluation criterion is as follows.

| | | | |
|---|---|---|---|
| Starting torque: | less than 1000 mN · m | Good | ∘ |
| | 1000 mN · m or more | Bad | x |

### (3) Boot Resistance

Measurement in accordance with JIS K 6258.

Volume change at 120° C. for 72 hours was measured.

The evaluation criterion is as follows.

| | | | |
|---|---|---|---|
| Boot resistance: | 0 to less than +5% | Good | ∘ |
| | 0% or less, or +5% or more | Bad | x |

### (4) SRV Friction Coefficient

| | | |
|---|---|---|
| Test piece | Ball | Diameter 10 mm (SUJ-2) |
| | Plate | Diameter 24 mm × 7.85 mm (SUJ-2) |
| Test | Load | 500 N |
| condition | Frequency | 40 Hz |
| | Amplitude | 1500 μm |
| | Time | 60 minutes |
| | Test temperature | 150° C. |

| | |
|---|---|
| Measurement | The average of the friction coefficients during the last 5 |
| item | minutes. |

### (5) Heat Release Test (Temperature Control Performance)

| | | |
|---|---|---|
| Test conditions | Rotation speed | 6000 rpm |
| | Torque | 200 Nm |
| | Joint angle | 3° |
| | Operating time | 100 h |
| Joint type | Cross groove type joint | |

| | |
|---|---|
| Measurement | Surface temperature of the outer race of the joint |
| item | |

The evaluation criterion is as follows.

Temperature control performance:

| | | | |
|---|---|---|---|
| Joint temperature | less than 120° C. | Good | ∘ |
| Joint temperature | 120° C. or more | Bad | x |

Raw materials and formulations of the base oils used in Examples and Comparative Examples are shown in Table 1.

TABLE 1

| Type of oil | Alcohol | Carboxylic acid | Note |
|---|---|---|---|
| Ester synthetic oil (a) | Isodecyl alcohol | Trimellitic acid | Present invention |
| Ester synthetic oil (b) | 2-Ethyl-1-hexanol | Trimellitic acid | Present invention |
| Ester synthetic oil (c) | 1-Octanol | Trimellitic acid | Present invention |
| Ester synthetic oil (d) | 2-Octyldodecanol | Pyromellitic acid | Present invention |
| Ester synthetic oil (e) | Dipentaerythritol | 2-Ethylhexanoic acid | Comparative Example |
| Ester synthetic oil (f) | Pentaerythritol | Octanoic acid | Comparative Example |

| | | |
|---|---|---|
| Synthetic hydrocarbon | Poly-α-olefin | Present invention |
| oil (g) | | |

MoDTC: molybdenum dialkyldithiocarbamate (In Formula 2, R³ and R⁴ represent C₄ alkyl, m represents 0 to 3, and n represents 1 to 4.)
ZnDTP: zinc dithiophosphate (In Formula 3, R⁵ represents C₃-C₆ alkyl.)
Formulation ingredients and evaluation results of the grease compositions of the Examples and the Comparative Examples are shown in Tables 2 to 4. The number in parentheses in the line of each base oil component in Tables 2 to 4 represents % by mass of the component in the base oil.

TABLE 2

| | Example | Example | Example | Example |
|---|---|---|---|---|
| | 1 | 2 | 3 | 4 |
| A. Base oil | 81 | 81 | 81 | 81 |
| Ester synthetic oil (a) | (20) | | | |
| Ester synthetic oil (b) | | (20) | | |
| Ester synthetic oil (c) | | | (20) | |
| Ester synthetic oil (d) | | | | (20) |
| Ester synthetic oil (e) | | | | |
| Ester synthetic oil (f) | | | | |
| Synthetic hydrocarbon | (80) | (80) | (80) | (80) |
| oil (g) | | | | |
| B. Thickener | 15 | 15 | 15 | 15 |
| C. MoS₂ | 2.5 | 2.5 | 2.5 | 2.5 |
| D. MoDTC | 0.5 | 0.5 | 0.5 | 0.5 |
| E. ZnDTP | 1.0 | 1.0 | 1.0 | 1.0 |
| Viscosity of base oil | 32.0 | 29.4 | 31.2 | 35.6 |
| Low-temperature torque | | | | |
| Starting | 560 | 680 | 610 | 660 |
| Running | 290 | 380 | 300 | 320 |
| Boot resistance, Volume | +2.0 | +2.6 | +3.1 | +2.4 |
| change | | | | |
| SRV friction coefficient | 0.05 | 0.05 | 0.05 | 0.05 |
| Temperature control | 110 | 102 | 104 | 108 |
| performance, joint | | | | |
| temperature | | | | |
| Low-temperature | ∘ | ∘ | ∘ | ∘ |
| performance | | | | |
| Boot resistance | ∘ | ∘ | ∘ | ∘ |
| Temperature control | ∘ | ∘ | ∘ | ∘ |
| performance | | | | |

TABLE 3

| | Comparative | Comparative | Comparative | Comparative |
|---|---|---|---|---|
| | Example 1 | Example 2 | Example 3 | Example 4 |
| A. Base oil | 81 | 81 | 81 | 81 |
| Ester synthetic oil (a) | | | | |
| Ester synthetic oil (b) | | | | |
| Ester synthetic oil (c) | | | (100) | |
| Ester synthetic oil (d) | | | | |
| Ester synthetic oil (e) | (10) | | | |
| Ester synthetic oil (f) | | (20) | | |
| Synthetic hydrocarbon oil (g) | (90) | (80) | | (100) |
| B. Thickener | 15 | 15 | 15 | 15 |
| C. MoS₂ | 2.5 | 2.5 | 2.5 | 2.5 |
| D. MoDTC | 0.5 | 0.5 | 0.5 | 0.5 |
| E. ZnDTP | 1.0 | 1.0 | 1.0 | 1.0 |
| Viscosity of base oil | 33.3 | 28.0 | 9.6 | 40.7 |
| Low-temperature torque | | | | |
| Starting | 1300< | 1300< | 540 | 680 |
| Running | —*⁵ | —*⁵ | 200 | 350 |
| Boot resistance, Volume change | −5.2 | +2.3 | +12.1 | −9.2 |
| SRV friction coefficient | 0.05 | 0.05 | 0.12 | 0.13 |
| Temperature control performance, | 106 | 106 | — | — |
| joint temperature | | | | |
| Low-temperature performance | x | x | ∘ | ∘ |
| Boot resistance | x | ∘ | x | x |
| Temperature control performance | ∘ | ∘ | x | x |

TABLE 4

| | Comparative | Comparative | Comparative | Comparative |
|---|---|---|---|---|
| | Example 5 | Example 6 | Example 7 | Example 8 |
| A. Base oil | 83.5 | 83.5 | 83.5 | 83.5 |
| Ester synthetic oil (a) | | | | |
| Ester synthetic oil (b) | | (20) | | |
| Ester synthetic oil (c) | (100) | | (20) | (20) |
| Ester synthetic oil (d) | | | | |
| Ester synthetic oil (e) | | | | |
| Ester synthetic oil (f) | | | | |
| Synthetic hydrocarbon oil (g) | | (80) | (80) | (80) |
| B. Thickener | 15 | 15 | 15 | 15 |
| C. MoS₂ | 0 | 0 | 0 | 0 |
| D. MoDTC | 0.5 | 0.5 | 0.5 | 0 |
| E. ZnDTP | 1.0 | 1.0 | 1.0 | 0 |
| Viscosity of base oil | 29.4 | 29.4 | 29.4 | 29.4 |
| Low-temperature torque | | | | |
| Starting | 730 | 720 | 750 | 690 |
| Running | 370 | 300 | 350 | 320 |
| Boot resistance, Volume change | +10.7 | +1.4 | +2.1 | +3.0 |
| SRV friction coefficient | 0.16 | 0.08 | 0.07 | Seizing |
| Temperature control performance, | — | — | — | — |
| joint temperature | | | | |
| Low-temperature performance | ∘ | ∘ | ∘ | ∘ |
| Boot resistance | x | ∘ | ∘ | ∘ |
| Temperature control performance | x | x | x | x |

—*⁵: Incapable of measuring the rotational torque since the starting torque was too high (1300<) at low temperature.

### RESULTS

As seen from the results, the grease compositions of Examples 1 to 4 of the present invention for a constant velocity joint, wherein a base oil (A) containing 10 to 95% by mass of an ester synthetic oil produced from an aliphatic alcohol and an aromatic carboxylic acid and 90 to 5 weight percent of a synthetic hydrocarbon oil is used and the components (C) to (E) are included as additives, are excellent in low-temperature performance, boot resistance and temperature control performance and show low friction coefficients.

In contrast, Comparative Example 1, wherein an ester synthetic oil produced from an aliphatic alcohol and an aliphatic carboxylic acid was used instead of the component (A) of the present invention, shows poorer low-temperature performance and boot resistance.

Comparative Example 2 of the present invention which does not contain the component (A) shows poorer low-temperature performance.

Comparative Examples 3 and 5 wherein only an ester synthetic oil was used as the base oil shows poorer boot resistance and temperature control performance.

Comparative Example 4 wherein only a synthetic hydrocarbon oil was used as the base oil shows poorer boot resistance and temperature control performance.

Comparative Examples 6 to 7 which do not contain molybdenum disulfide show poorer temperature control performance.

Comparative Example 8 which does not contain MoDTC and ZnDTP shows poorer temperature control performance and causes seizing.

1. A method for lubricating a cross groove type constant velocity joint for a propeller shaft with a grease composition, which comprises the following components (A) to (E):
(A) a base oil containing 10 to 95% by mass of an ester synthetic oil produced from an aliphatic alcohol and an aromatic carboxylic acid and 90 to 5% by mass of a synthetic hydrocarbon oil;
(B) a diurea thickener consisting of one or more compounds represented by the following General Formula (I)
R¹NH—CO—NH—C₆H₄-p-CH₂-C₆H₄-p—NH—CO—NHR² (I)
wherein R¹ and R² are the same or different and are selected from the group consisting of hexadecyl, octadecyl and oleyl;
(C) molybdenum disulfide;
(D) molybdenum dialkyldithiocarbamate; and
(E) zinc dithiophosphate,
wherein the content of the diurea thickener is 5 to 20% by mass based on the total mass of the grease composition.

2. The method according to claim 1, wherein the synthetic hydrocarbon oil of the component (A) is a poly-α-olefin.

3. The method according to claim 1, wherein the ester synthetic oil of the component (A) is produced from a C₆⁻C₂₂ aliphatic alcohol and a C₈-C₂₂ aromatic carboxylic acid having 2 to 6 carboxyl groups.

4. The method according to claim 1, wherein each of the contents of molybdenum disulfide of the component (C), molybdenum dialkyldithiocarbamate of the component (D) and zinc dithiophosphate of the component (E) is 0.1 to 10% by mass based on the total mass of the grease composition.

5. A propeller shaft comprising a cross groove type constant velocity joint in which a grease composition is filled, the grease composition comprising the following components (A) to (E):
(A) a base oil containing 10 to 95% by mass of an ester synthetic oil produced from an aliphatic alcohol and an aromatic carboxylic acid and 90 to 5% by mass of a synthetic hydrocarbon oil;
(B) a diurea thickener consisting of one or more compounds represented by the following General Formula (I)
R¹NH—CO—NH—C₆H₄-p—CH₂-C₆H₄-p—NH—CO—NHR² (I)
wherein R¹ and R² are the same or different and are selected from the group consisting of hexadecyl, octadecyl and oleyl;
(C) molybdenum disulfide;
(D) molybdenum dialkyldithiocarbamate; and
(E) zinc dithiophosphate,
wherein the content of the diurea thickener is 5 to 20% by mass based on the total mass of the grease composition.

6. A method for lubricating a cross groove type constant velocity joint for a propeller shaft with a grease composition, which comprises the following components (A) to (E):
(A) a base oil containing 10 to 95% by mass of an ester synthetic oil produced from an aliphatic alcohol and an aromatic carboxylic acid and 90 to 5% by mass of a synthetic hydrocarbon oil;
(B) one or more thickener chosen from the group consisting of diurea thickeners consisting of one or more compounds represented by the following General Formula (I)
R¹NH—CO—NH—C₆H₄-p—CH₂-C₆H₄-p—NH—CO—NHR² (I)
wherein R¹ and R² are the same or different and are selected from the group consisting of hexadecyl, octadecyl and oleyl;
(C) molybdenum disulfide;
(D) molybdenum dialkyldithiocarbamate; and
(E) zinc dithiophosphate,
wherein the content of the diurea thickener is 5 to 20% by mass based on the total mass of the grease composition.

7. The method according to claim 6, wherein the synthetic hydrocarbon oil of the component (A) is a poly-α-olefin.

8. The method according to claim 6, wherein the ester synthetic oil of the component (A) is produced from a C₆⁻C₂₂ aliphatic alcohol and a C₈-C₂₂ aromatic carboxylic acid having 2 to 6 carboxyl groups.

9. The method according to claim 6, wherein each of the contents of molybdenum disulfide of the component (C), molybdenum dialkyldithiocarbamate of the component (D) and zinc dithiophosphate of the component (E) is 0.1 to 10% by mass based on the total mass of the grease composition.

10. A propeller shaft comprising a cross groove type constant velocity joint in which a grease composition is filled, the grease composition comprising the following components (A) to (E):
(A) a base oil containing 10 to 95% by mass of an ester synthetic oil produced from an aliphatic alcohol and an aromatic carboxylic acid and 90 to 5% by mass of a synthetic hydrocarbon oil;
(B) one or more thickener chosen from the group consisting of diurea thickeners consisting of one or more compounds represented by the following General Formula (I)
R¹NH—CO—NH—C₆H₄-p—CH₂-C₆H₄-p—NH—CO—NHR² (I)
wherein R¹ and R² are the same or different and are selected from the group consisting of hexadecyl, octadecyl and oleyl;
(C) molybdenum disulfide;
(D) molybdenum dialkyldithiocarbamate; and
(E) zinc dithiophosphate,
wherein the content of the diurea thickener is 5 to 20% by mass based on the total mass of the grease composition.
